(19) United States
(12) Patent Application Publication
(10) Pub. No.: US 2026/0124880 A1
(43) Pub. Date: May 7, 2026

(54) USE OF A TEMPERATURE MEASUREMENT POINT IN A COMPRESSOR TO CONTROL A TEMPERATURE OF A REFRIGERANT CIRCUIT, METHOD FOR CONTROLLING A TEMPERATURE OF A REFRIGERANT CIRCUIT, COMPRESSOR AND VEHICLE

(71) Applicant: Schaeffler Technologies AG & Co. KG, Herzogenaurach (DE)

(72) Inventors: Gerhard Eser, Hemau (DE); Sebastian Brettner, Burglengenfeld (DE); Manuel Dillinger, Kelheim (DE); Markus Feulner, Ensdorf (DE)

(73) Assignee: Schaeffler Technologies AG & Co. KG, Herzogenaurach (DE)

(21) Appl. No.: 19/119,625

(22) PCT Filed: Oct. 12, 2023
(86) PCT No.: PCT/EP2023/078430

§ 371 Date: Apr. 9, 2025

(30) Foreign Application Priority Data
Oct. 14, 2022 (DE) 10 2022 210 862.0

(51) Int. Cl. B60H 1/32; B60H 1/00

(52) U.S. Cl. CPC B60H 1/3205; B60H 1/00271; B60H 2001/00307

(57) ABSTRACT

A use of at least one temperature measurement point in a compressor to control a temperature of a refrigerant circuit, wherein the temperature measurement point is used between power electronics of the compressor, around which power electronics a refrigerant flowing into the compressor flows and which power electronics are cooled by the refrigerant, and a compressor stage, which is downstream of the power electronics in the flow direction of the refrigerant. A method for controlling a temperature of a refrigerant circuit, to a compressor and to a vehicle.

### CROSS-REFERENCE TO RELATED APPLICATIONS

This application claims priority to PCT Application PCT/EP2023/078430, filed Oct. 12, 2023, which claims priority to German Patent Application No. DE 10 2022 210 862.0, filed Oct. 14, 2022. The disclosures of the above applications are incorporated herein by reference.

### FIELD OF THE INVENTION

The present invention relates to a use of a temperature measurement point in a compressor to control a temperature of a refrigerant circuit, to a method for controlling a temperature of a refrigerant circuit, to a compressor and to a vehicle.

### SUMMARY OF THE INVENTION

It is an object of the present invention to improve the temperature control of a refrigerant circuit.

This object is achieved by a use of a temperature measurement point in a compressor. A method for controlling a temperature of a refrigerant circuit is furthermore proposed. Additionally, a compressor and a vehicle are proposed.

A use of at least one temperature measurement point in a compressor to control a temperature of a refrigerant circuit is proposed, wherein the temperature measurement point is used between power electronics of the compressor, around which power electronics a refrigerant flowing into the compressor flows and which power electronics are cooled by the refrigerant, and a compressor stage, which is downstream of the power electronics in the flow direction of the refrigerant. The temperature measurement point is therefore located or provided downstream of the power electronics and upstream of the compressor stage.

A temperature measurement point is a point on the compressor at which a temperature is measured or recorded using a measuring element of a temperature sensor or transducer. The temperature sensor or transducer may be provided at least for the most part outside or inside the compressor or compressor housing. The temperature sensor or transducer may be located in and/or on the compressor housing.

The proposed location of the temperature measurement point enables the temperature of the refrigerant to be measured accurately before it enters the compressor stage. This enables precise temperature control of the refrigerant circuit to a so-called superheating temperature in the vapor region of the refrigerant. This in turn requires the best possible efficiency of the refrigerant circuit.

In one embodiment, at least one pressure measurement point is used between the power electronics and the compressor stage. This allows the pressure of the refrigerant to be accurately measured before it enters the compressor stage. In this case, a pressure drop that occurs due to the flow around the power electronics is detected. Thus, using the recorded temperature and pressure information, an actual operating point of the refrigerant may be precisely determined in a so-called pressure-enthalpy state diagram or p-h diagram of the refrigerant. This requires an improvement in the temperature control or the efficiency.

A pressure measurement point is a point on the compressor at which a pressure is measured or recorded using a measuring element of a pressure sensor or transducer. The pressure sensor or transducer may be provided at least for the most part outside or inside the compressor or compressor housing. The pressure sensor or transducer is located or installed in and/or on the compressor housing.

In a further embodiment, at least one temperature sensor is used with the temperature measurement point and/or at least one pressure sensor is used with the pressure measurement point in and/or on the compressor.

The temperature sensor and/or the pressure sensor is electrically connected to the power electronics.

A method for controlling a temperature of a refrigerant circuit is furthermore proposed, in which a temperature to be controlled is measured in a compressor of the refrigerant circuit at a measurement point between power electronics of the compressor, around which power electronics a refrigerant flowing into the compressor flows and which power electronics are cooled by the refrigerant, and a compressor stage, which is downstream of the power electronics in the flow direction of the refrigerant. The temperature measurement point is therefore located or provided downstream of the power electronics and upstream of the compressor stage.

The proposed location of the temperature measurement point enables the temperature of the refrigerant to be measured accurately before it enters the compressor stage. This enables precise temperature control of the refrigerant circuit to a so-called superheating temperature in the vapor region of the refrigerant. This in turn requires the best possible efficiency of the refrigerant circuit.

Furthermore, a compressor for a refrigerant circuit is proposed in which at least one temperature measurement point is provided between power electronics of the compressor and a compressor stage that is arranged downstream of the power electronics in the direction of flow of a refrigerant. The temperature measurement point is therefore located or provided downstream of the power electronics and upstream of the compressor stage.

At least one pressure measurement point may also be provided between the power electronics and the compressor stage.

In an embodiment, at least one temperature sensor is provided with the temperature measurement point and/or at least one pressure sensor is provided with the pressure measurement point in and/or on the compressor. The temperature sensor and/or the pressure sensor may be electrically connected to the power electronics.

In another embodiment, the temperature sensor and/or the pressure sensor is/are installed in the power electronics. The temperature sensor and/or the pressure sensor may be designed as a structure that is at least partially printed onto the power electronics.

A vehicle with a refrigerant circuit for air conditioning a passenger compartment is also proposed, wherein the refrigerant circuit has a compressor of the type described above.

A vehicle is intended in this instance to be understood to be any type of vehicle operated either by an internal combustion engine and/or an electric motor, such as passenger cars and/or commercial vehicles. These are partially autonomously and may be fully autonomously operated vehicles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will be explained in detail below with reference to the illustrations in the figures. Further developments of the invention can be found in the following description of preferred embodiments. In this respect, in the partially schematic figures:

FIG. 1 shows a proposed compressor and

FIG. 2 shows a pressure-enthalpy graph, or p-h graph, illustrating a refrigerant circuit.

### DETAILED DESCRIPTION OF THE PREFERRED EMBODIMENTS

The following description of the preferred embodiment(s) is merely exemplary in nature and is in no way intended to limit the invention, its application, or uses.

The suggested compressor 2—also called a compressor—is part of a refrigerant circuit in a vehicle. The refrigerant circuit is used for air conditioning a passenger compartment and includes a compressor 2 with a housing, which includes power electronics 6 of the compressor 2 and a compressor stage 4, which is downstream of the power electronics 6 in the direction of flow of a refrigerant and which compresses and delivers the refrigerant in the refrigerant circuit.

A temperature measurement point 8 is provided between the power electronics 6 and the compressor stage 4 in order to precisely measure a so-called superheating temperature of the refrigerant before it enters the compressor stage 4 and to be able to precisely control the refrigerant circuit to this superheating temperature. The temperature measurement point 8 is therefore located or provided downstream of the power electronics 6 and upstream of the compressor stage 4.

In addition to the temperature measurement point 8, a pressure measurement point 10 is also provided between the power electronics 6 and the compressor stage 4, which, in conjunction with the temperature measurement point 8, enables an exact recording of a working point of the refrigerant in a p-h graph and thus an exact control of the refrigerant circuit with regard to the superheating temperature. The temperature measurement point 8 and the pressure measurement point 10 are therefore located or provided downstream of the power electronics 6 and upstream of the compressor stage 4.

A refrigerant inlet 12 leads into the compressor housing, whereas a refrigerant outlet 14 leads away from the compressor housing or from the compressor stage 4.

As the refrigerant flows into the compressor housing, it flows around the power electronics 6, cooling them in the process. The waste heat or heat loss from the power electronics 6 additionally heats or warms the refrigerant to the aforementioned heating temperature.

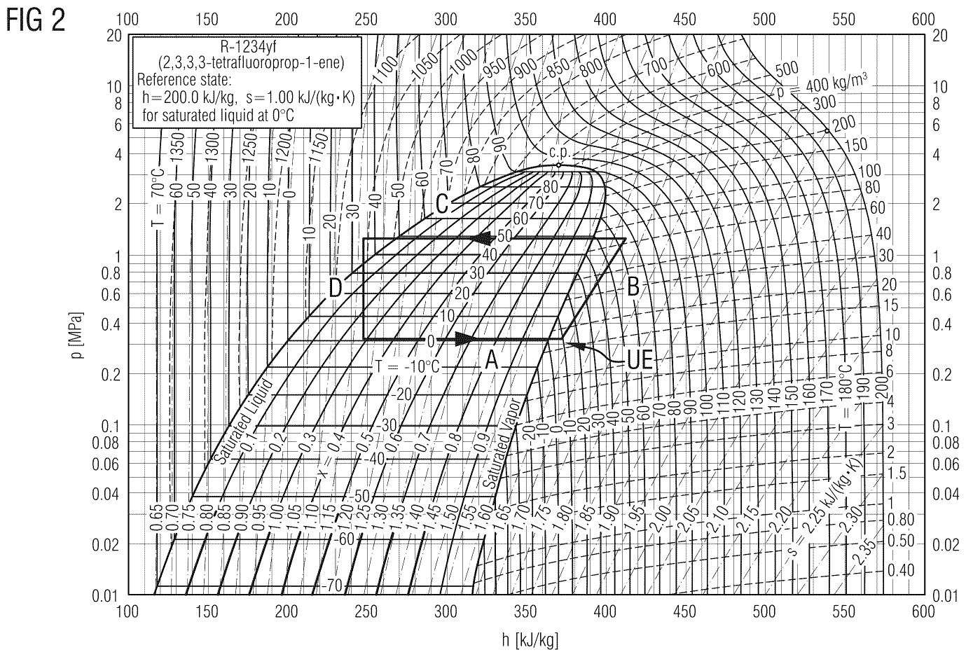

FIG. 2 shows an example of a so-called pressure-enthalpy state graph, or p-h graph, of the refrigerant R—1234yf. In this state graph, the specific enthalpy h is plotted on the abscissa axis and the pressure p on the ordinate axis.

This p-h graph also shows a refrigerant circuit (see the lines A, B, C, D drawn in). Line A indicates evaporation, line B compression, line C condensation and line D expansion of the refrigerant.

The aim is to control this refrigerant circuit to achieve the desired superheating temperature of the refrigerant. This superheating temperature is represented by the point or corner or superheating point UE, which is formed by the lines A and B. Along line A, the refrigerant is evaporated up to the so-called dew line and beyond that point, i.e., up to point UE to the right of the dew line, it is slightly superheated before it finally flows into the compressor stage 4 in a completely vaporous or gaseous state and is compressed to a higher temperature and pressure level.

In contrast to a temperature measurement point before compressor 2, the proposed location of temperature measurement point 8 allows a precise recording of a desired superheating temperature of the refrigerant to the right of the dew line in the so-called vapor region of the refrigerant and thus an accurate temperature control of the refrigerant circuit to this superheating temperature.

In conjunction with the proposed pressure measurement point 10, the exact operating point of the refrigerant may be determined and set in the p-h graph to the right of the dew line in the vapor region of the refrigerant.

In contrast to a temperature measurement point before the compressor 2—which only allows a relatively high or large superheating of the refrigerant—a desired, slight, i.e., minimal or necessary superheating of the refrigerant of approximately 2 to 10K may be set beyond the so-called dew line by a corresponding control of the compressor stage. An unintentional falsification or distortion of the operating point of the refrigerant in the p-h graph due to heat input into the refrigerant when the latter flows around the power electronics 6 is avoided. This requires the temperature of the refrigerant circuit to be controlled precisely to the specified superheating temperature. And because the desired superheating of the refrigerant is set as low as possible, i.e., no higher or greater than necessary, the efficiency of the refrigerant circuit is improved.

The optimum efficiency of the refrigerant circuit is achieved when the refrigerant is almost completely vaporised before entering the compressor 2. In FIG. 2, this corresponds to a point just before the dew point along the line A, so that the refrigerant heats or warms up additionally as a result of the air flow around the power electronics 6 up to the point or overheating point UE to the right of the dew point. This overheating point UE corresponds to an overheating of the refrigerant by approximately 2 to 10K to the right of the dew line, more specifically depending on the efficiency of the refrigerant circuit and the heat loss of the power electronics 6.

In an alternative embodiment—not represented by the figures—a pressure measurement point is not provided between the power electronics 6 and the compressor stage 4, but before compressor 2. In this context, attention must be paid to any pressure loss that occurs as a result of the refrigerant flowing around the power electronics 6, which could be estimated, for example.

In a further, alternative embodiment—not represented by the figures—a pressure measurement point is provided both before compressor 2 and between the power electronics 6 and the compressor stage 4. This allows the pressure loss caused by the refrigerant flowing around the power electronics 6 to be accurately measured.

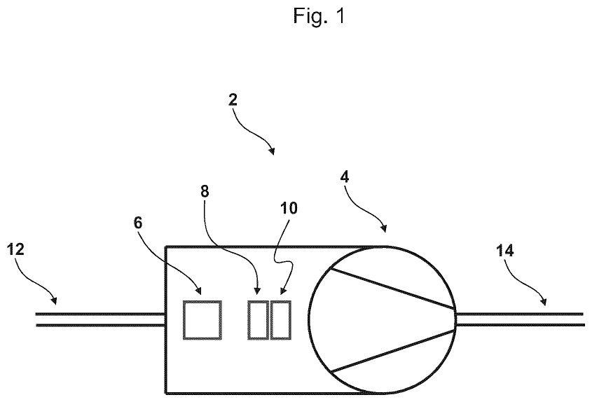

According to FIG. 1, a temperature sensor having a temperature measurement point 8 and/or a pressure sensor having a pressure measurement point 10 is provided in and/or on the compressor 2. The temperature sensor and the pressure sensor may form a sensor unit or a so-called p-T sensor or pressure-temperature sensor.

Alternatively, a temperature sensor connected to the temperature measurement point 8 and/or a pressure sensor connected to the pressure measurement point 10 or a sensor unit formed of a temperature sensor connected to the temperature measurement point 8 and a pressure sensor connected to the pressure measurement point 10—or a so-called p-T sensor—may be provided outside or at least mostly outside the compressor 2.

In a further embodiment—not represented by the figures—the temperature sensor and/or the pressure sensor is/are electrically connected to the power electronics 6.

In a further embodiment—not represented by the figures—the temperature sensor and/or the pressure sensor is/are installed in the power electronics 6. The temperature sensor and/or the pressure sensor may be designed as a structure that is at least partially printed onto the power electronics. This embodiment enables a cost-effective realization of a temperature and/or pressure sensor system on the power electronics 6 of the compressor 2.

Although exemplary embodiments have been explained in the preceding description, it should be noted that a large number of modifications are possible. Furthermore, it should be noted that the exemplary embodiments are only examples which are in no way intended to limit the protective scope, the applications and the structure. Instead, the person skilled in the art with the above description is given a guideline for the implementation of at least one exemplary embodiment, wherein various changes, such as with regard to the function and arrangement of the described components, may be carried out without departing from the protective scope and these equivalent feature combinations.

The description of the invention is merely exemplary in nature and, thus, variations that do not depart from the gist of the invention are intended to be within the scope of the invention. Such variations are not to be regarded as a departure from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. The use of at least one temperature measurement point in a compressor to control a temperature of a refrigerant circuit, wherein the temperature measurement point is used between power electronics of the compressor, around which power electronics a refrigerant flowing into the compressor flows and which power electronics are cooled by said refrigerant, and a compressor stage, which is downstream of the power electronics in the flow direction of the refrigerant.

14. The use of claim 13, wherein at least one pressure measurement point is additionally used between the power electronics and the compressor stage.

15. The use of claim 13, wherein at least one temperature sensor is used with the temperature measurement point and/or at least one pressure sensor is used with the pressure measurement point in and/or on the compressor.

16. The use of claim 15, wherein the temperature sensor and/or the pressure sensor is/are electrically connected to the power electronics.

17. A method for controlling a temperature of a refrigerant circuit, comprising the steps of:
providing a compressor of a refrigerant circuit;
providing power electronics of the compressor;
providing a compressor stage located downstream of the power electronics in the flow direction of a refrigerant, such that the refrigerant flowing into the compressor flows around the power electronics and the power electronics are cooled by the refrigerant; and
providing a measurement point located between the power electronics and the compressor stage;
measuring a temperature of the refrigerant in the compressor at the measurement point such that the temperature is controlled.

18. A compressor for a refrigerant circuit, comprising:
power electronics;
a compressor stage arranged downstream from the power electronics in the direction of flow of a refrigerant;
at least one temperature measurement point is located between the power electronics and the compressor stage.

19. The compressor of claim 18, further comprising at least one pressure measurement point between the power electronics and the compressor stage.

20. The compressor of claim 19, further comprising:
at least one temperature sensor is provided with the temperature measurement point in and/or on the compressor; and/or
at least one pressure sensor is provided with the pressure measurement point in and/or on the compressor.

21. The compressor of claim 20, wherein the temperature sensor and/or the pressure sensor is/are electrically connected to the power electronics.

22. The compressor of claim 21, wherein the temperature sensor and/or the pressure sensor is/are installed in the power electronics.

23. The compressor of claim 22, wherein the temperature sensor and/or the pressure sensor is in the form of a structure which is at least partially printed onto the power electronics.

24. A vehicle with a refrigerant circuit for air conditioning a passenger compartment, wherein the refrigerant circuit has a compressor of claim 18.
